(19) United States
(12) Patent Application Publication
(10) Pub. No.: US 2012/0196466 A1
(43) Pub. Date: Aug. 2, 2012

(54) Flexible Cable Connector

(76) Inventors: Isao Igarashi, Tokyo (JP); Shinsuke Kunishi, Kanagawa (JP)

(21) Appl. No.: 13/359,819

(22) Filed: Jan. 27, 2012

(30) Foreign Application Priority Data
Jan. 28, 2011 (JP) 2011-016736
Apr. 22, 2011 (JP) 2011-095846

(51) Int. Cl. H01R 13/62

(52) U.S. Cl. 439/329

(57) ABSTRACT

A flexible cable connector is provided for connecting to a flexible cable having an end section with conductors arranged therein in a width direction and notches formed in both side edges. The flexible cable connector includes a housing, a plurality of contacts, a pair of engagement arms, and a shield shell. The housing includes a cable receiving passageway formed therein. The plurality of contacts are arranged in the cable receiving passageway along a width direction. The pair of engagement arms engage with respective notches disposed along both side edges of the flexible cable to prevent disconnection of the flexible cable. The shield shell includes a shield section, which surrounds the housing, and a pair of engagement release arms which extend from the shield section and release the pair of engagement arms from the notches.

### CROSS-REFERENCE TO RELATED APPLICATION

This application claims the benefit of the filing dates under 35 U.S.C. §119(a)-(d) of Japanese Patent Application No. 2011-016736, filed on Jan. 28, 2011, and Japanese Patent Application No. 2011-095846, filed on Apr. 22, 2011

### FIELD OF THE INVENTION

The present invention relates to a cable connector and, more particularly, a flexible cable connector having a pair of releasable engagement arms.

### BACKGROUND

Among connectors, flexible cable connectors are used to connect with a flexible cable. Here, the flexible cable is a cable, for example, such as a flexible flat cable and a flexible printed circuit. Such a flexible cable is provided with a plurality of long extending conductors arranged in a width direction. In addition, among flexible cables, there is a type in which a shield layer is provided.

Japanese Patent Publication JP 2008-52993A discloses a known flexible printed circuit connector that connects to a flexible printed circuit. The flexible printed circuit connector of the Japanese Patent Publication JP 2008-52993A includes a shield plate to cover the housing and the seesaw-type lock section to prevent disconnection of flexible printed circuit. One edge of the lock section engages with the notch provided with the flexible printed circuit, and the other edge of the lock section is arranged at the position to engage the point of the lever to which a force is applied by an actuator which is rotatably arranged. The actuator is rotationally operated to a closed position in the rear of the flexible printed circuit connector to engage the lock section with the flexible printed circuit, and rotationally operated to an opened position in the upper of the flexible printed circuit by being raised to release the engagement of the lock section.

In addition, Japanese Patent Publication JP H08-180940A discloses a connector which is provided with lock means to engage with an flexible printed circuit. The connector of Japanese Patent Publication JP H08-180940A has lock claws to engage with projected sections provided on both sides of the flexible printed circuit and a slider which is a member separately formed from a housing. When the connector is connected to a flexible printed circuit, while the slider is first pulled out from the housing, the flexible printed circuit is inserted to a predetermined position of the housing, and next, the slider is pushed into the housing to engage the lock claw with the flexible printed circuit.

Each of the connectors of Japanese Patent Publication JP 2008-52993A and Japanese Patent Publication JP H08-180940A has a member such as the actuator and the slider to prevent disconnection of the flexible printed circuit, and thus has a large number of parts. In addition, the connector of Japanese Patent Publication JP 2008-52993A is required to secure a space for rotationally operating the actuator. Further, in the connector of Japanese Patent Publication JP H08-180940A, removing of the flexible printed circuit is not taken into consideration. In other words, even when the slider is pulled out, the engagement of the lock claw with the flexible printed circuit is not released. In addition, in the connector of Japanese Patent Publication JP H08-180940A, the shielding capabilities may not be obtained in the connector portion.

### SUMMARY

The invention has been made in view of the above circumstances to address the problems described above, among others, and provides a flexible cable connector which has a small number of parts while having the shielding capability and also reduces an arrangement space including a space for an operation of releasing disconnection prevention.

The flexible cable connector includes a housing, a plurality of contacts, a pair of engagement arms, and a shield shell. The housing includes a cable receiving passageway formed therein. The plurality of contacts are arranged in the cable receiving passageway along a width direction. The pair of engagement arms engage with respective notches disposed along both side edges of the flexible cable to prevent disconnection of the flexible cable. The shield shell includes a shield section, which surrounds the housing, and a pair of engagement release arms which extend from the shield section and release the pair of engagement arms from the notches.

### BRIEF DESCRIPTION OF THE DRAWINGS

The objects, features and advantages of the invention will become more apparent by describing in detail embodiments thereof with reference to the accompanying drawings, in which:

FIG. 1 is a front perspective view of a flexible flat cable connector according to the invention;

FIG. 2 is a rear perspective view of the flexible flat cable connector in FIG. 1;

FIG. 3A is a top view of the flexible flat cable connector shown in FIGS. 1 and 2;

FIG. 3B is a front view of the flexible flat cable connector shown in FIGS. 1 and 2;

FIG. 4 is a front perspective view of the flexible flat cable connector according to the invention showing a housing and a shield shell;

FIG. 5 is a rear perspective view of the flexible flat cable connector showing the housing and shield shell;

FIG. 6 is a front view of the shield shell shown in FIGS. 4 and 5;

FIG. 7 is a cross sectional view showing an engagement arm of the flexible flat cable connector shown in FIG. 1;

FIG. 8 is a perspective view showing a flexible flat cable connected to the flexible flat cable connector shown in FIG. 1;

FIG. 9 is a partial front view of the flexible flat cable connector shown in FIG. 1;

FIG. 10 is a front perspective view another flexible flat cable connector according to the invention;

FIG. 11 is a rear perspective view the flexible flat cable connector shown in FIG. 10;

FIG. 12A is a top view of the flexible flat cable connector shown in FIGS. 10 and 11;

FIG. 12B is a front view of the flexible flat cable connector shown in FIGS. 10 and 11;

FIG. 13 is front perspective view of the flexible flat cable connector shown in FIGS. 10 and 11, showing a housing and a shield shell;

FIG. 14 is rear perspective view of the flexible flat cable connector shown in FIGS. 10-13;

FIG. 15 is a front view of the shield shell shown in FIGS. 13 and 14; and

FIG. 16 a cross sectional view showing an engagement arm of the flexible flat cable connector shown in FIG. 10.

### DETAILED DESCRIPTION OF THE EMBODIMENT(S)

In the following, exemplary embodiments according to the present invention will be explained with reference to the drawings.

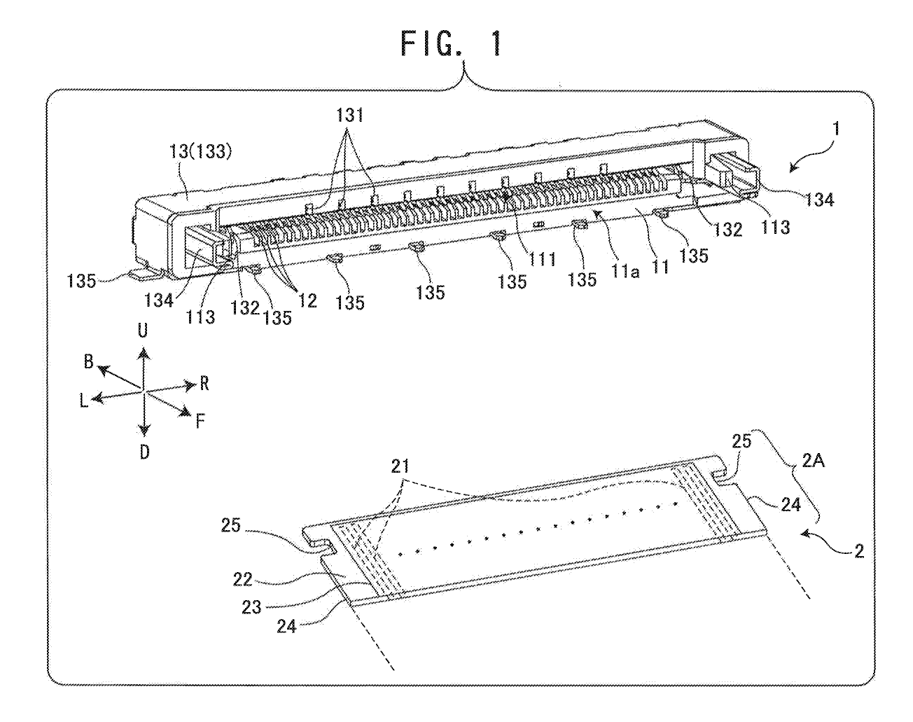

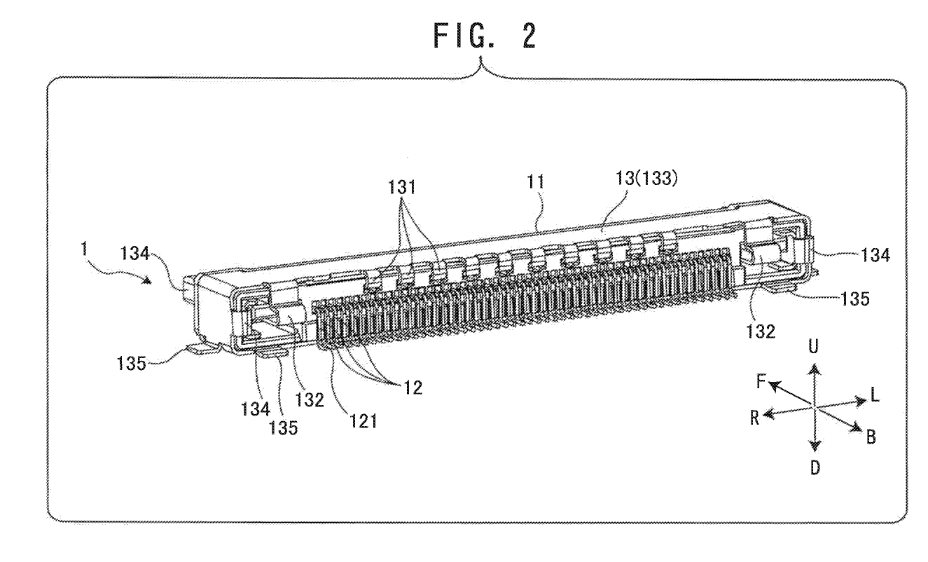

With reference to FIGS. 1-3, a flexible flat cable connector 1 according to the invention connects with an flexible flat cable 2. The flexible flat cable connector 1 may be used by being connected to a not-shown circuit board by soldering, and the flexible flat cable connector 1 is connected with the flexible flat cable 2 so as to make the flexible flat cable 2 and the circuit board electrically coupled together.

FIG. 1 shows an end section 2A of the long extending flexible printed circuit 2 in solid lines. In the embodiment shown, multiple elongated rectangle conductors 21 are arranged along the end section 2A of the flexible flat cable 2. In more detail, the flexible flat cable 2 includes a film 22 made of insulating material. The conductors 21 extending in a linear manner are arranged at a constant interval in a width direction across an entirety of the flexible flat cable 2 along one surface 3 (a front surface: the under surface in FIG. 1) of the film 22 (there is no reference numeral “3” in FIGS. 1-3). A shield 23 is provided on another surface (the rear surface: the top surface in FIG. 1) of the film 22. The shield 23 is a film that is electrically conductive and is spread over an area including all areas corresponding to the multiple conductors 21. Notches cuts 25 are formed at both side edges of the end section 2A of the flexible flat cable 2, respectively.

The flexible flat cable connector 1 includes a housing 11, a plurality of contacts 12, and a shield shell 13.

The housing 11 is a molded part made of insulating resin. A cable receiving passageway 111 that receives the end section 2A of the flexible flat cable 2 is formed in the housing 11. The cable receiving passageway 111 is a groove which extends in a narrow and linear manner in accordance with a shape of the end section 2A of the flexible flat cable 2.

Cable receiving passageway 111 is oriented to a front face 11a of the housing 11. In addition, a direction from the cable receiving passageway 111 of the housing 11 to the flexible flat cable 2, in other words, a direction which the front face 11a faces, is referred to as a frontward direction F, and a direction opposite to the frontward direction is referred to as a backward direction B. In addition, a direction in which the housing 11 and the cable receiving passageway 111 extend is referred to as a rightward direction R and a leftward direction L in a manner consistent with the flexible flat cable 2 received in the cable receiving passageway 111. In addition, directions intersecting each of the frontward direction F, the backward direction B, the rightward direction R and the leftward direction L are referred to as an upward direction U and a downward direction D. Here, a side in which the conductors 21 received in the cable receiving passageway 111 of the flexible flat cable 2 are arranged corresponds to the downward direction D, and a side in which the shield 23 of the flexible flat cable 2 is arranged corresponds to the upward direction U.

The contacts 12 are members which are formed by stamping and forming a metal plate having electrical conductivity, and are press-fitted and fixed to the housing 11. The contacts 12 are provided in the same manner as the conductors 21, in the flexible flat cable 2, and are arranged in the cable receiving passageway 111 in the left direction L and right direction R. The flexible flat cable connector 1 makes contact with each of the conductors 21 arranged along the end section 2A of the flexible flat cable 2 when received in the cable receiving passageway 111. A part of each of the contacts 12 projects from the housing 11 in the backward direction B to be a rear end 121 of the contact 12 which is connected to a conductor pattern of circuit board (not shown) by soldering in a surface mount manner.

In addition, a plurality of shield contacts 131 are provided in the cable receiving passageway 111 to contact the shield 23 of the flexible flat cable 2. The shield contacts 131 are arranged at positions opposite to the contacts 12 in the cable receiving passageway 111 across the end section 2A between the contacts 12 and the contacts on both sides in the upward U and downward D directions. The shield contacts 131 form a part of the shield shell 13, and contact the shield 23 of the flexible flat cable 2 to maintain the whole shield shell 13 at the same potential (usually, ground potential) as that of the shield 23 of the flexible flat cable 2.

A pair of engagement arms 132 are positioned at both ends in left L and right R directions of the cable receiving passageway 111, respectively. The engagement arms 132 engages in the notches 25 at both side edges 24 of the flexible flat cable 2 to prevent disconnection of the end section 2A of the flexible flat cable 2 when the flexible flat cable 2 is received in the cable receiving passageway 111. In the shown embodiment, the engagement arms 132 form a part of the shield shell 13.

The shield shell 13 is a member formed by stamping and forming an electrically conductive metal plate. The shield shell 13 includes a shield section 133 and a pair of engagement release arms 134 in addition to the above-described shield contacts 131 and the engagement arms 132. The pair of engagement release arms 134 are arranged at positions across the end section 2A of the flexible flat cable 2 there between in the left direction L and right direction R, and project in the frontward direction F from the front which the cable receiving passageway 111 of the housing faces.

A plurality of solder connection pieces 135 to be connected by soldering in a surface mount manner to a conductor pattern of a circuit board (not shown) are provided along a lower part of the shield section 133. The solder connection pieces 135 are connected by soldering to the conductor pattern of the circuit board (not shown) so that the flexible flat cable connector 1 is fixed to the circuit board. The shield section 133 surrounds the housing 11, and the shield contacts 131 electrically couple with the shield 23 of the flexible flat cable 2 and the solder connection pieces 135 are grounded to the circuit board so that the shield section 133 electromagnetically shields the whole flexible flat cable connector 1.

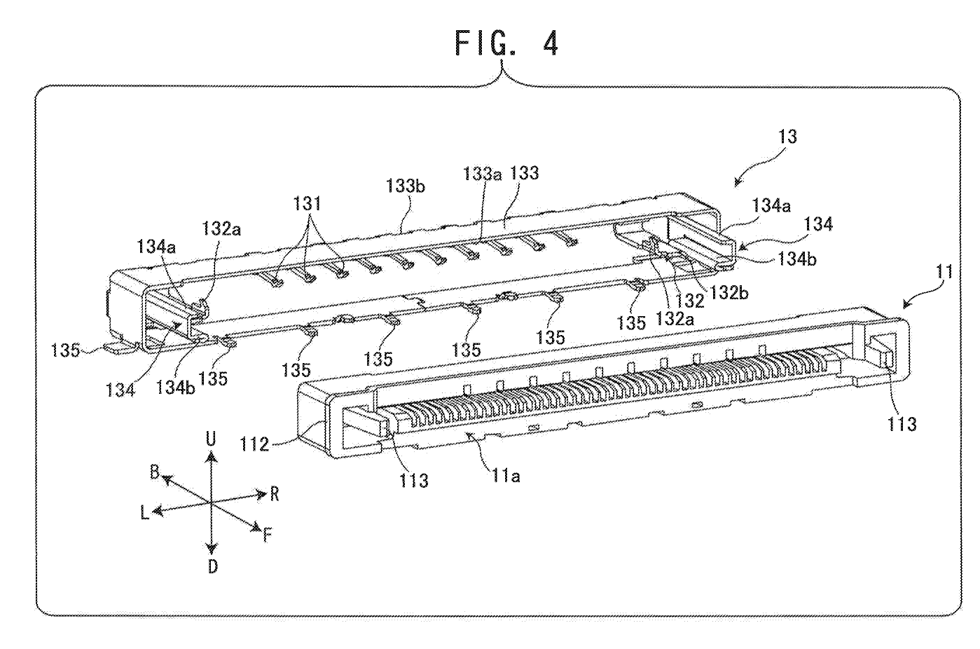

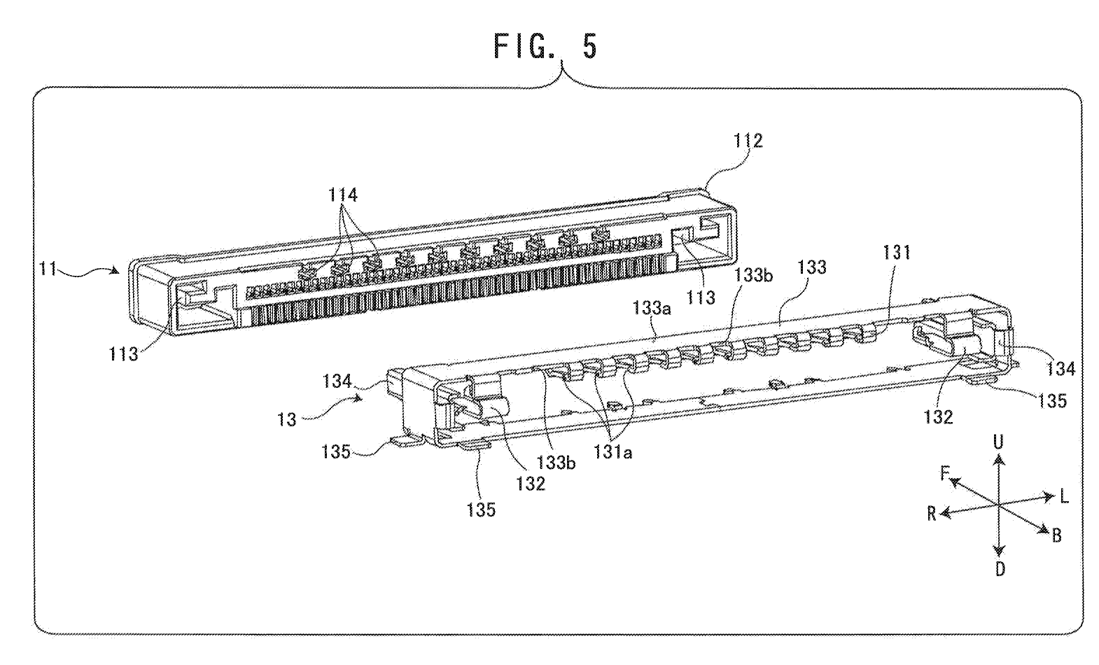

Each of FIGS. 4 and 5 is a perspective view illustrating a state in which the housing 11 and the shield shell 13 shown in FIGS. 1 to 3 are separated from each other.

The shield shell 13 includes the shield contacts 131, the engagement arms 132, the shield section 133, the engagement release arms 134 and the solder connection pieces 135. The shield section 133 is an annular belt surrounding the housing 11. When the flexible flat cable connector 1 (see FIG. 1) is assembled, the housing 11 is fitted in the annular shield section 133. A flange 112 is formed to project outwardly on a rim of a front face 11 a of the housing 11. As the housing 11 is inserted backwardly from the front side of the shield shell 13 into the shield shell, the flange 112 of the housing 11 abuts on an edge 133a on the front side of the shield section 133. In the state in which the flange 112 abuts on the edge 133a of the shield section 133, insertion of the housing 11 into the shield shell is completed.

Each of the shield contacts 131, the engagement arms 132, the engagement release arms 134 and the solder connection pieces 135 extends from the shield section 133 of the shield shell 13. In other words, the shield section 133, the shield contacts 131, the engagement arms 132, the engagement release arms 134 and the solder connection pieces 135 are formed as a portion of the shield shell 13 which is a one piece member in the embodiment shown. In more detail, each of the shield contacts 131, the engagement arms 132 and the engagement release arms 134 extends backward from the edge 133b on the rear side of the shield section 133 in the backward direction B, and bends halfway to extend in the frontward direction F. In other words, each of the shield contacts 131, the engagement arms 132 and the engagement release arms 134 is supported by the shield section 133 in a cantilever form, in the embodiment shown. Thus, each of the shield contacts 131, the engagement arms 132 and the engagement release arms 134 receives an external force at a tip portion to elastically deform and incline.

A press-fitting section 13 la extends in the forward direction F from the shield contacts 131 of the shield section 133. When the flexible flat cable connector 1 (see FIG. 1) is assembled, the press-fitting section 131a is press-fitted into a press-fitting slot 114 so that the housing 11 and the shield shell 13 are engaged and secured with each other. At this point, a tip forward of the press-fitting section 131a of the shield contact 131 is exposed inside the cable receiving passageway 111 of the housing 11.

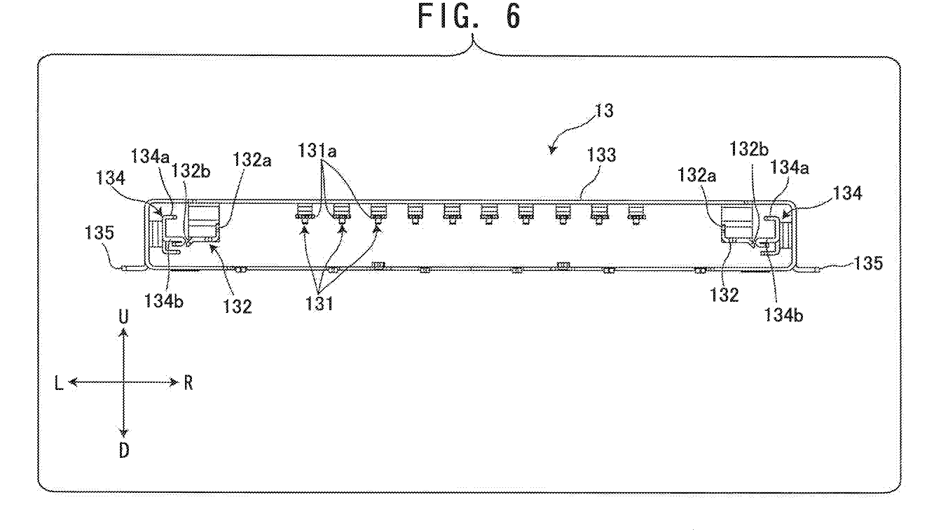

As shown in FIGS. 4 and 6 in more detail, the engagement section 132a to engage with the end section 2A of the flexible flat cable 2 (see FIG. 1) is positioned at a tip portion extending in the forward direction F from the shield section 133 of the engagement arm 132. In the embodiment shown, the engagement section 132a is a hook-shaped projection projecting in the upward direction U, and projects from below to enter the notch 25 of the side edge of the end section 2A of the flexible flat cable 2 received in the cable receiving passageway 111 (see FIG. 1).

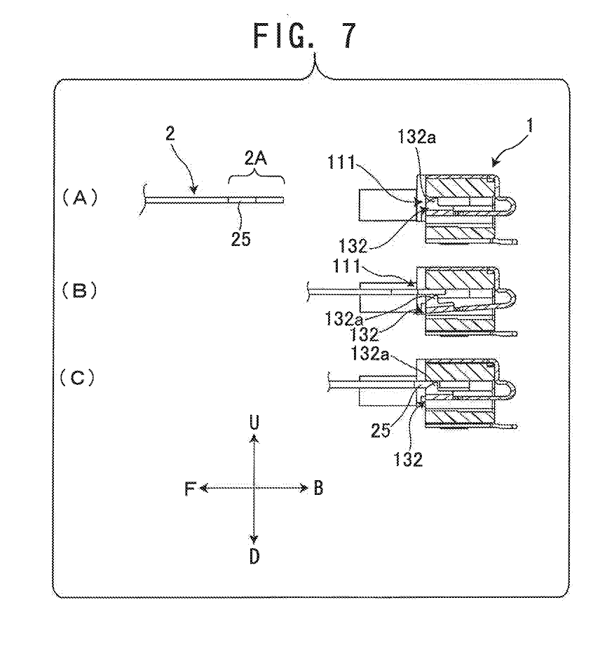

With reference to FIG. 7, the flexible flat cable 2 is shown being inserted into the cable receiving passageway 111 of the flexible flat cable connector 1.

As shown in part (B) of FIG. 7, when the end section 2A of the flexible flat cable 2 is inserted into the cable receiving passageway 111, the end section 2A presses down the engagement section 132a of the engagement arm 132 in the downward direction D. As shown in part (C) of FIG. 7, when the end section 2A is completely inserted in the cable receiving passageway 111, the engagement arm 132 returns in the upward direction U by the elastic force, and the engagement section 132a enters from below in the notch 25 of the end section 2A.

The description will be continued with reference to FIGS. 4 to 6 again.

The cam inclined surface 132b (see FIGS. 4 and 6) which inclines in the downward direction D toward the adjacent engagement release arm 134 is provided at a tip portion of the engagement arm 132. The pair of engagement release arms 134 are formed in a lateral U-shape to open and face with each other, and as shown in FIG. 6 in more detail, the pair of engagement release arms 134 includes an upper piece 134a and a lower piece 134b which form the lateral U-shape in the embodiment shown. An edge of the lower piece 134b of the engagement release arm 134 is close to the cam inclined surface 132b of the engagement arm 132, and acts on the cam inclined surface 132b when the engagement release arm 134 is operated. The lower piece 134b has an edge folded back tightly. Thanks to this folded edge, the cam engagement of the lower piece 134b with the cam inclined surface 132b may be performed smoothly, and since the thickness is increased by the folding over the lower piece 134b, it is possible to increase a large displacement amount of the engagement arm 132.

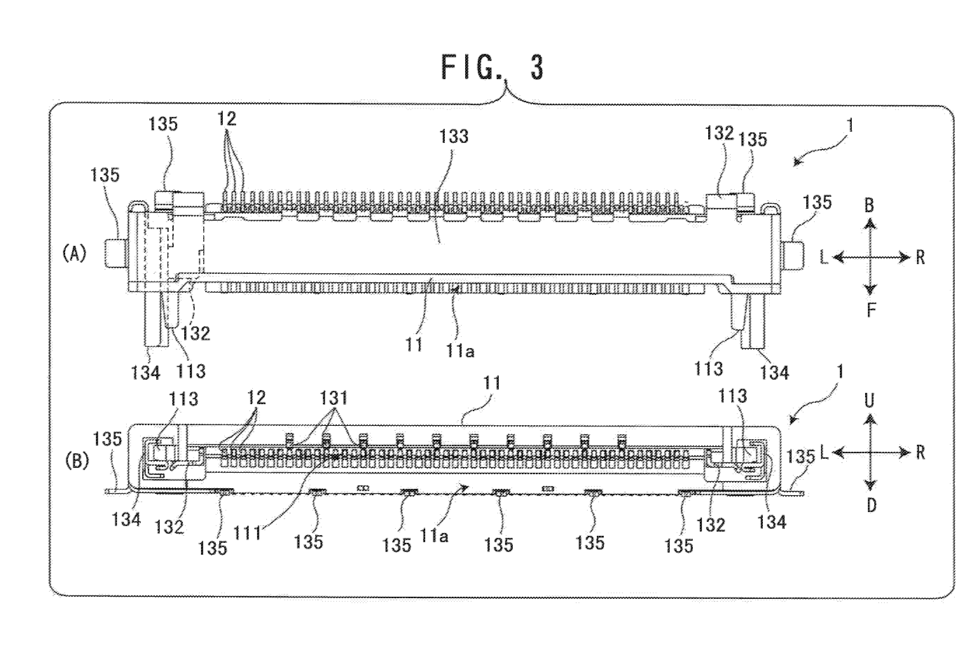

As shown in FIGS. 4 and 5, the housing 11 includes a pair of guide projection 113 at positions on both edges in the left direction L and right direction R of the cable receiving passageway 111. As shown in FIG. 3, each of the guide projections 113 is arranged inside the pair of engagement release arms 134 formed in the U-shape respectively in a state in which the flexible flat cable connector 1 is assembled. The upper piece 134a and the lower piece 134b of each of the engagement release arm 134 are arranged across the guide projection 113 there between from above and below, and guide the engagement release arm 134 in the left direction L and right direction R.

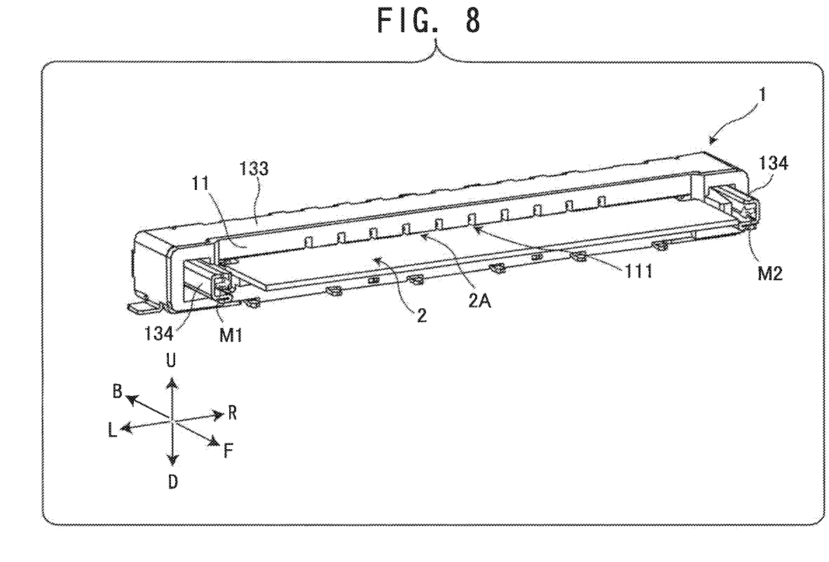

FIG. 8 is a perspective view showing a flexible flat cable is connected to the flexible flat cable connector shown in FIG. 1.

When the flexible flat cable 2 is connected to the flexible flat cable connector 1, the end section 2A of the flexible flat cable 2 is inserted into the cable receiving passageway 111 of the flexible flat cable connector 1. As shown in FIG. 8, when the end section 2A of the flexible flat cable 2 is inserted into the cable receiving passageway 111 of the flexible flat cable connector 1, the conductors 21 (see FIG. 1) of the flexible flat cable 2 make contact with the contacts 12 (see FIG. 1) of the flexible flat cable connector 1, respectively, to make an electrical connection. In addition, the shield 23 (see FIG. 1) of the flexible flat cable 2 makes contact with the shield contacts 131 (see FIG. 1) of the flexible flat cable 2 to be electrically connected to the shield section surrounding the housing 11. The solder connection pieces 135 of the shield shell 13 are connected and grounded to the conductive pattern of the circuit board. Thus, the flexible flat cable connector 1 is shielded. In addition, as explained with reference to FIG. 7, the engagement sections 132a (see part (B) of FIG. 7) project and enter into the notches 25 in the end section 2A of the flexible flat cable 2 to prevent the flexible flat cable 2 from being pulled out. Accordingly, even if a force to pull the flexible flat cable 2 forward is applied, the flexible flat cable 2 is not pulled out (not disconnected) from the flexible flat cable connector 1.

When the flexible flat cable 2 is removed from the flexible flat cable connector 1, the flexible flat cable 2 is released using the pair of engagement release arms 134. Specifically, the pair of engagement release arms 134 are caught by fingers so as to approach to each other. Receiving the catching force, the pair of engagement release arms 134 move in directions indicated by arrows M1 and M2 in the left direction L and right direction R, respectively. In other words, each of the engagement release arms provided on both sides in the left direction L and right direction R of the flexible flat cable 2 is driven toward the flexible flat cable 2 in the release operation.

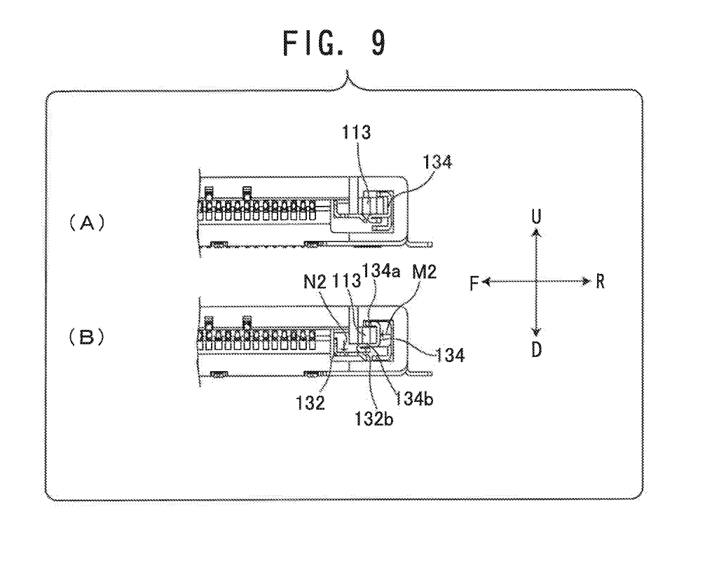

When the pair of engagement release arms 134 shown in FIG. 8 receive a catching force to approach to each other, the engagement release arm 134 of the right side shown in FIG. 9 moves in the direction indicated by the arrow M2. At this point, the folded edge of the lower piece 134b of the engagement release arm 134 acts on the cam inclined surface 132b of the engagement arm 132 to displace the tip of the engagement arm 132 downward as indicated by an arrow N2. The engagement section 132a entering from below into the notch 25 of the end section 2A of the flexible flat cable 2 is provided in the tip of the engagement arm 132, as explained with reference to FIG. 7. The tip of the engagement arm 132 is displaced in the downward direction D so that the engagement of the engagement section 132a with the notch 25 is released as shown in Part (B) of FIG. 7. In the state in which the engagement is released, the flexible flat cable 2 is held to be pulled in the frontward direction F so that the flexible flat cable 2 is removed from the flexible flat cable connector 1.

Since the pair of engagement release arms 134 move to approach to each other to release the engagement of the flexible flat cable 2, the release operation may be performed only by catching the pair of engagement release arms 134 with one hand. In addition, the engagement release arms 134 are arranged at the positions in which the upper piece 134a and the lower piece 134b sandwich the guide projection 113 from above and below, and are guided in the left direction L and right direction R by the guide projection 113. Thus, even when the force of the release operation is inclined in the upward and downward direction UD, an event in which the engagement release arms 134 are shifted in the upward and downward direction UD is avoided.

In the shown embodiment, since the pair of engagement release arms 134 project from the front which the cable receiving passageway 111 faces to the frontward direction F in which the flexible flat cable 2 extends, a space in which the flexible flat cable 2 is arranged and which is forward than the flexible flat cable connector 1 is utilized to perform the release operation. In more detail, a space is utilized to perform the release operation and which is slightly enlarged in the left direction L and right direction R more than the arrangement space of the flexible flat cable 2. For example, it is not required to secure a space for a release operation in a direction different from that of a space in which an flexible flat cable is arranged unlike the configuration shown in Japanese Patent Publication JP 2008-52993A. For example, it is possible to arrange other parts and a chassis tightly in an upper space of the flexible flat cable connector 1, and thus it is possible to downsize a device in which the flexible flat cable connector 1 is mounted.

In addition, in the shown embodiment, since the engagement release arms 134 form a part of the shield shell 13, it is possible to minimize the number of parts while securing the shield performance of the flexible flat cable connector 1 and the release function of the flexible flat cable 2.

Next, another embodiment of the present invention will be explained. In the following explanation of this embodiment, reference signs of elements same as that in the embodiment explained above will be omitted, and differences from the embodiment explained above will be mainly explained.

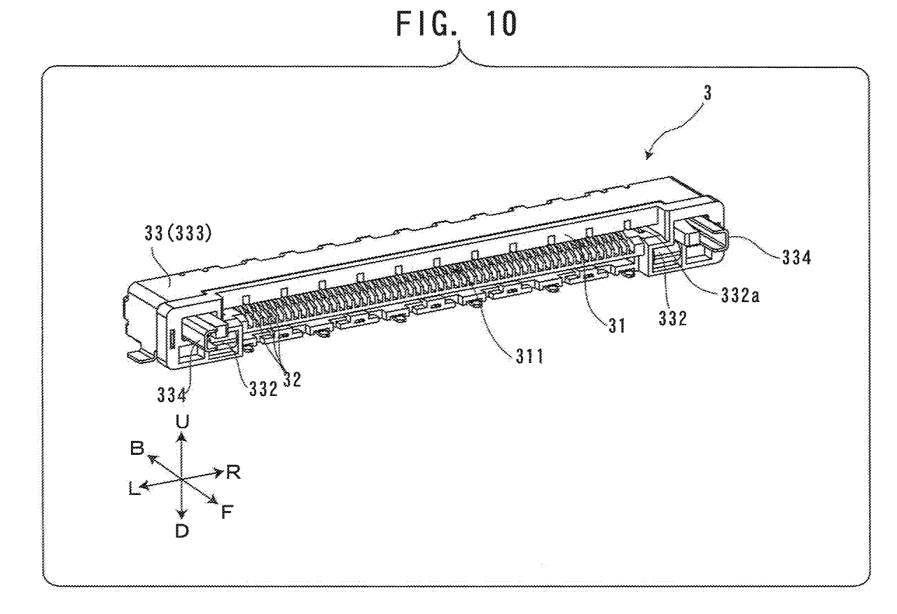

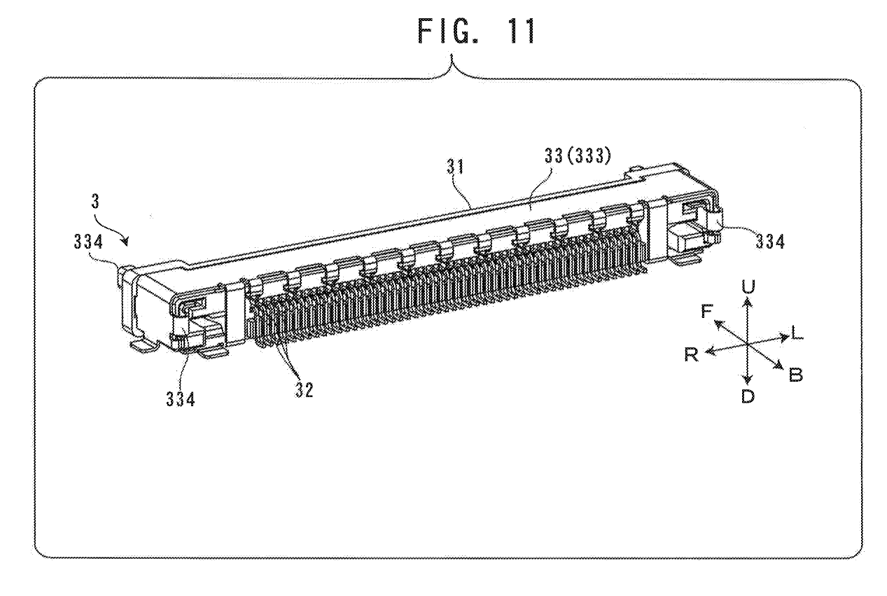

Each of FIGS. 10 and 11 is a perspective view showing an external appearance of an flexible flat cable connector 3that is connected to the flexible flat cable 2 (see FIG. 1) similarly to the connector 1 (see FIG. 1) of the first embodiment. The flexible flat cable connector 3 includes a housing 31, a plurality of contacts 32 and a shield shell 33.

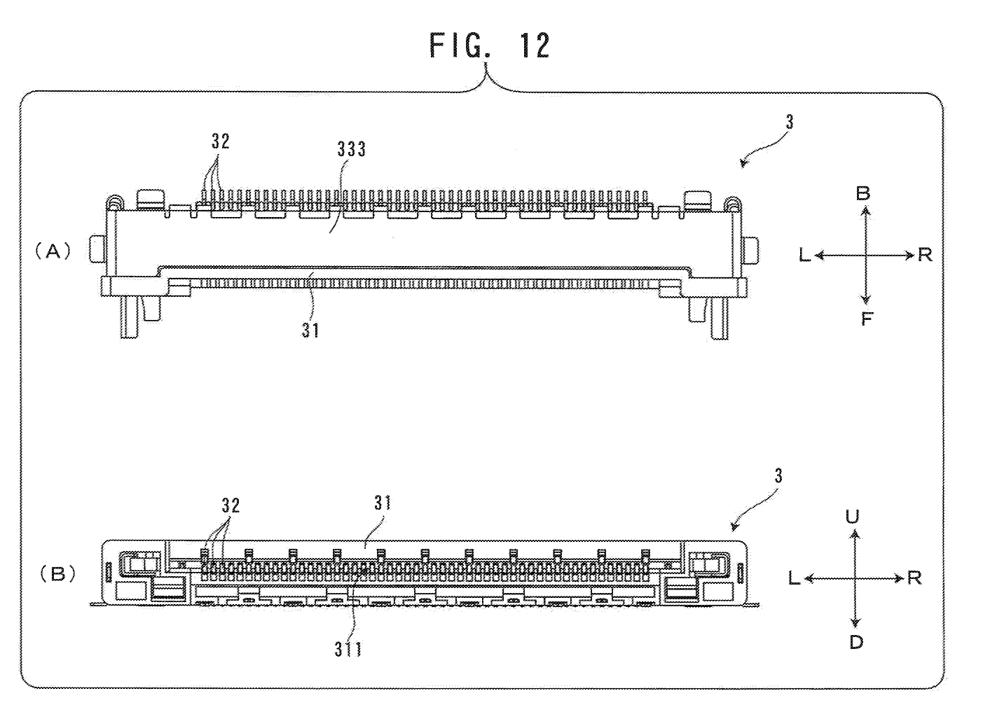

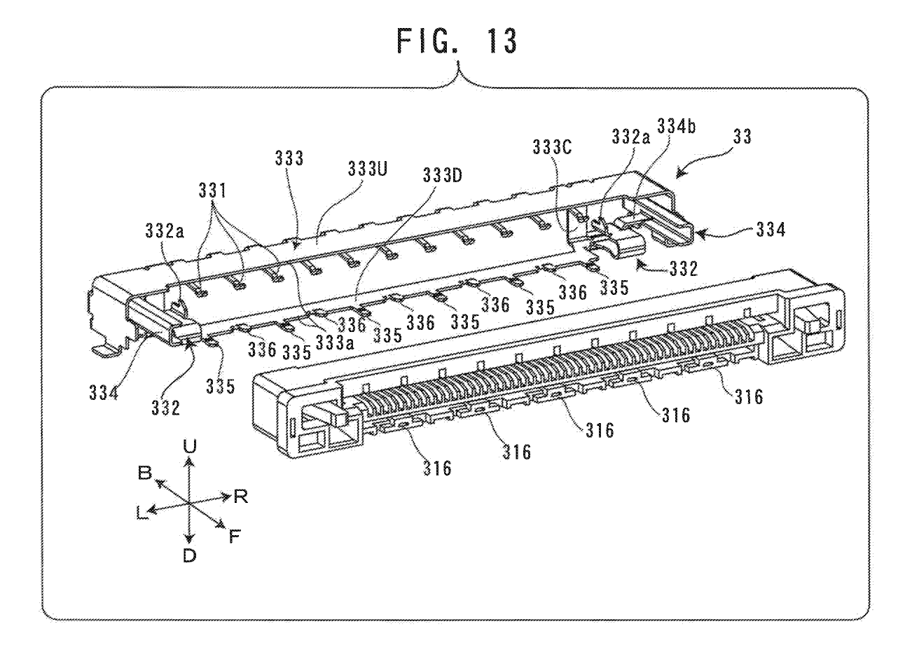

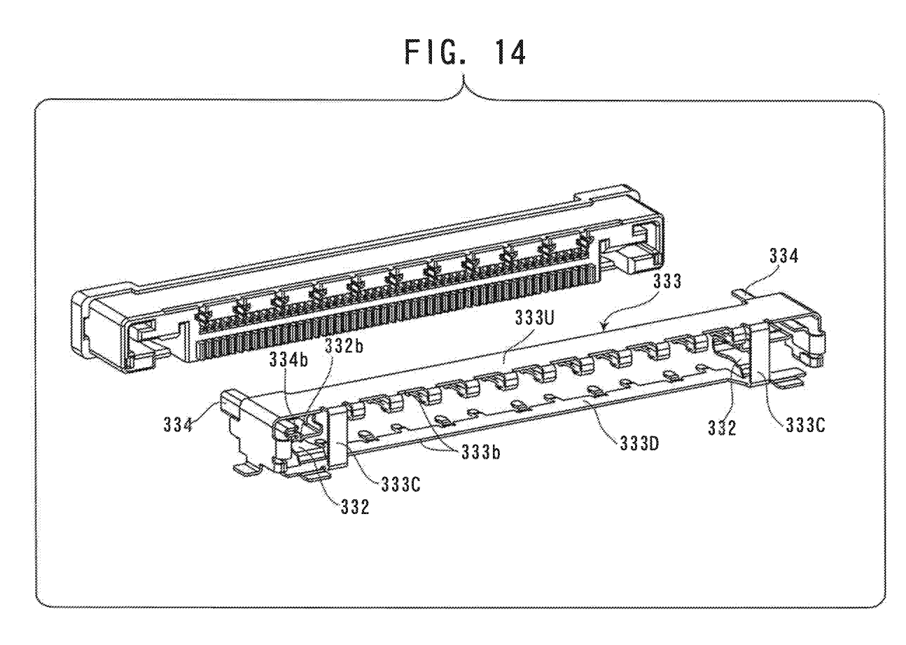

Each of FIGS. 13 and 14 is a perspective view showing the housing 31 and the shield shell 33 shown in FIGS. 10 to 12 in a state in which they are separated from each other. The shield shell 33 includes shield contacts 331, engagement arms 332, a shield section 333, engagement release arms 334 and solder connection pieces 335. The shield section 333 surrounds the housing 31. The shield section 333 in the showing embodiment has a structure in which a shield upper section 333U which is arranged along an upper face and side faces of the housing 31 and a shield lower section 333D which is arranged along a lower face of the housing 31 are coupled through two connection sections 333C extending along a rear face of the housing 31 in the upward and downward direction UD.

The shield contacts 331, the engagement arms 332, the engagement release arms 334 and the solder connection pieces 335 extend from the shield section 333 of the shield shell 33. In addition, connection pieces 336 to couple with the housing 31 are provided between all the adjacent solder connection pieces 335 in the shield lower section 333D of the shield section 333. Connection sections 316 to couple with the connection pieces 336 are provided in the housing 31. The connection pieces 336 enter the connection sections 316 from the backward B of the housing 31 to fix the shield lower section 333D to the housing 31.

Each of the shield contacts 331, the engagement arms 332, the engagement release arms 334 is supported by the shield section 333 in a cantilever manner.

Here, similar to the embodiment shown in FIGS. 4 and 5, the shield contacts 331 and the engagement release arms 334 extend in the backward direction B from the edge 333b on a rear side of the shield sections 333, and bend halfway to extend in the front direction F. However, the engagement arms in the second embodiment fold in front of the shield section 333 to extend in the backward direction B. In more detail, the engagement arms 332 extend in the forward direction F from the edge 333a on the front side of the shield section 333, and folds back halfway in the upward direction U where the cable receiving passageway (see FIG. 10) is provided to extend in the backward direction B.

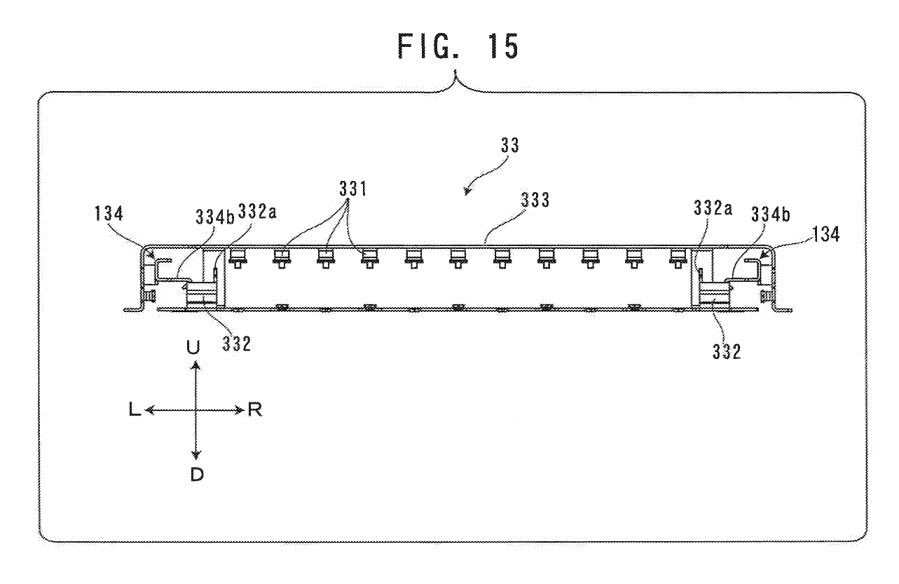

In addition, as shown in FIGS. 13 and 15, the engagement section 332a to engage with the end section 2A of the flexible flat cable 2 (see FIG. 1) are provided at a tip portion extending in the backward direction B from the shield section 333. The engagement sections 332a are projections projecting in the upward direction U and being in a hook shape. As shown in FIG. 10. the engagement arms 332 are surrounded by a wall of the housing 31 so as to be protected. In addition, the engagement sections 332a penetrate openings provided in the housing 31 to project inside the cable receiving passageway 311

Cam inclined surfaces 332b (see FIG. 14) inclined in the downward direction D toward the adjacent engagement release arms 334 are provided in tip portions of the engagement arms 332. The pair of engagement release arms 334 are formed in a lateral U-shape in which the engagement release arms 334 open to face with each other. A portion of the edge of the lower piece 334b of the engagement arm 332 project toward the engagement arm 332, and the projected tip is close to the cam inclined surface 332b of the engagement arm 332. The engagement release arm 334 is operated to act on the cam inclined surface 332b.

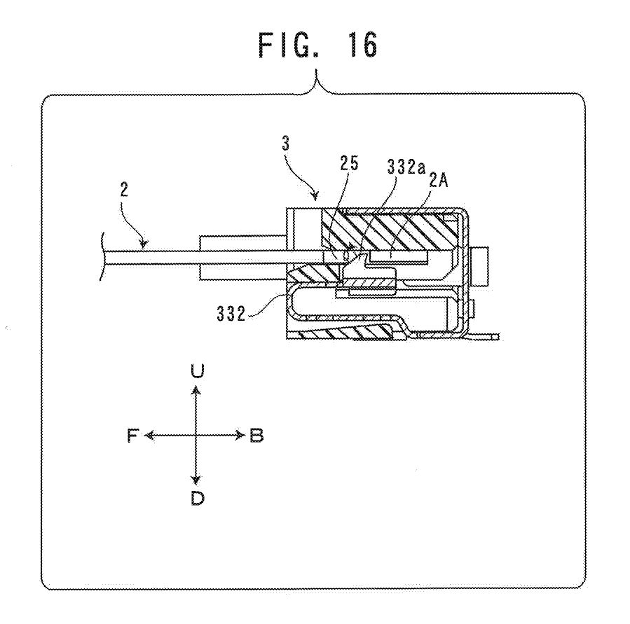

Now with reference to FIG. 16, a section passing through the engagement arm 332 of the flexible flat cable connector 3 shown in FIG. 10. The end section 2A of the flexible flat cable 2 is completely inserted in the cable receiving passageway 311, the engagement arm 332 which has been pressed and deformed by the end section 2A returns in the upward direction U by the elastic force, and the engagement section 332a enters the notch 25 of the end section 2A from below. The engagement section 332a enters the notch of the flexible flat cable 2 so that disconnection of the flexible flat cable is prevented.

The engagement arm 332 in the shown embodiment folds back on the front side of the shield section 333 to extend in the backward direction B. In addition, the engagement section 332s is provided in a tip portion extending in the backward direction B. Thus, when a force to pull the flexible flat cable 2 in the forward direction F is applied, a force to pull the engagement section 332a in the forward direction F is also applied. By this force, the engagement arm 332 extending in the backward direction B is deformed such that the engagement section 332a at the tip displaces in a forward oblique direction, i.e., a direction of an arrow Q. In other words, when a force to pull the flexible flat cable 2 in the forward direction F is applied, the engagement section 332a further enters into the notch 25 of the flexible flat cable 2. Accordingly, a retention force of the flexible flat cable 2 is improved and further withstands an enforcing removal of the flexible flat cable 2.

In the flexible flat cable connector 3 of the shown embodiment, similarly to the first embodiment, a release operation is performed for the pair of engagement release arms 334 so that the flexible flat cable 2 is released. Specifically, the pair of engagement release arms are caught by a hand such that the pair of engagement release arms approach to each other, and thereby, the pair of engagement release arms 334 move in directions indicated by the left direction L and right direction R, respectively. At this point, the folded back edge of the lower piece 334b of the engagement release arm 334 acts on the cam inclined surface 332b of the engagement arm 332 to displace the tip of the engagement arm 332 in the downward direction D. The tip of the engagement arm 332 is displaced in the downward direction D so that the engagement of the engagement section 332a is released.

Incidentally, in the above-explained embodiments, as the flexible cable connector according to the present invention, the flexible flat cable connectors to connect an flexible flat cable are exemplified. However, the flexible cable connector according to the present invention may be any flexible cable connector having an end section in which the plurality of conductors are arranged in its width direction. For example, the flexible cable connector according to the invention may be a connector to connect to an flexible printed circuit in which a conductor is printed on an insulating substrate having a film form. Here, the flexible cable may be a flexible cable in which, in a portion other than an end section, conductors windingly extend and are not arranged in a width direction, for example, as seen in an flexible printed circuit.

In addition, in the above-explained embodiments, the engagement arms to form a part of the shield shell is described as an example of the engagement arm according to the present invention. However, the invention is not limited to this. For example, the engagement arm may be a projection provided in the housing. In a case in which the engagement arm forms a part of a shield shell made of metal, the engagement arm is robust. Accordingly, when a strong force to pull out the flexible cable is applied, since the flexible cable is damaged before the connector is, damage of the connector which requires lots of work may be avoided.

Although several embodiments have been shown and described, it would be appreciated by those skilled in the art that various changes or modifications may be made in these embodiments without departing from the principles and spirit of the disclosure, the scope of which is defined in the claims and their equivalents.

As used herein, an element or step recited in the singular form and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, the wording “comprising” does not exclude additional elements or steps.

What is claimed is:

1. A flexible cable connector for connecting with a flexible cable, the flexible cable connector comprising:
a housing having a cable receiving passageway adapted to receive the flexible cable;
a plurality of contacts arranged in the cable receiving passageway;
a pair of engagement arms individually disposed at opposite ends of the cable receiving passageway and arranged to individually engage with a corresponding pair of notches disposed along side edges of the flexible cable to prevent disconnection of the flexible cable from the flexible cable connector; and
a shield shell having:
(a) a shield section surrounding the housing, and
(b) a pair of engagement release arms extending from the shield section for individually releasing the pair of engagement arms from notches in the flexible cable.

2. The flexible cable connector according to claim 1, wherein the pair of engagement arms extend from the shield shell and form portions of the shield shell.

3. The flexible cable connector according to claim 1, wherein each of the engagement arms include an engagement section which projects upwardly for entry into its associated notch.

4. The flexible cable connector according to claim 3, wherein each engagement arm further includes a cam surface which is inclined downwardly toward the engagement release arm associated with the engagement arm from which the cam surface is inclined downwardly.

5. The flexible cable connector according to claim 4, wherein the pair of engagement release arms press the cam surface that press the pair of engagement arms down to release the pair of engagement arms from the notches.

6. The flexible cable connector according to claim 2, wherein each of the pair of engagement arms includes a respective engagement section which projects upwardly and enters into its associated notch.

7. The flexible cable connector according to claim 6, wherein each engagement arm further includes a cam surface which is inclined downwardly toward the engagement release arm associated with the engagement arm from which the cam surface is inclined downwardly.

8. The flexible cable connector according to claim 7, wherein the pair of engagement release arms press the cam surface that press the pair of engagement arms down to release the pair of engagement arms from the notches.

9. The flexible cable connector according to claim 1, wherein the housing further includes a plurality of guiding projections adjacent to an inside of the pair of engagement release arms in the width direction.

10. The flexible cable connector according to claim 1, wherein the pair of engagement release arms include a plurality of guide receiving sections which catch the plurality of guiding projections from above and below and are guided by the plurality of guiding projections.

11. The flexible cable connector according to claim 1, wherein each of the pair of engagement arms are folded in front of the shield section and extend backward, respectively, and the respective engagement sections disposed at tip portions there of extending in respective rear directions of the pair of engagement arms.
